(19) United States
(12) Patent Application Publication
(10) Pub. No.: US 2011/0065486 A1
(43) Pub. Date: Mar. 17, 2011

(54) Ergonomic hard case for communication device

(76) Inventor: Fred Bayrami, Yaphank, NY (US)

(21) Appl. No.: 12/584,777

(22) Filed: Sep. 12, 2009

(51) Int. Cl. H04M 1/00

(52) U.S. Cl. 455/575.8

(57) ABSTRACT

The present invention relates to a hard case for the containment of a communication device, such as a cell phone, PDA, or pocket PC. Also, the disclosed invention is a method for use of the hard case as follows, communication device is accessible by pressing push button releasing to open position cover. Further, the disclosed invention has two modes of use. The first mode is the tabletop mode in which the hard case is placed on a surface with hand holding element in open position thus angularly elevating hard case for easy viewing and use of enclosed communication device. The second mode of use, hard case is placed in a single hand with fingers engaging finger holes and hand palm engaging grooved non-slip grip.

### 1. CROSS REFERENCE TO RELATED APPLICATIONS

The instant nonprovisional patent application contains subject matter disclosed in provisional patent application No. 61/188,821, filed on Aug. 13, 2008, for a ERGONOMIC HARD CASE FOR COMMUNICATION DEVICE, and incorporated herein by reference thereto.

### 2. BACKGROUND OF THE INVENTION

A. Field of the Invention

The present invention relates to a hard case commonly used for the storage and protection of a portable communication device. Also, the present invention is ergonomic in design and easily usable with one hand. The system incorporates one-handed holding means, specifically a finger hole system and a grooved rubber gripping pad. Additionally, the disclosed hard case has the ability to hold a communication device in a tilted manner for easy use.

B. Description of the Prior Art

Numerous innovations showing hard cases for communication devices are shown in the prior art that will be described. Even though these innovations may be suitable for the specific individual purposes to which they address, however, they differ from the present invention.

(1) U.S. Pat. No. 7,180,451 to Silzer, Jr.
both of which can be made of rubber or some other elastic material for absorbing shock when the PDA is in use in the field. The PDA can also have an antenna which is also part of the peripheral bumper or that is inset to minimize damage to the antenna. The antenna receives signals from a remote location, such as a global positioning so that the PDA can display useful information to the user. In a golf context, this could be the distance from the user to a golf hole. The casing of the PDA can also be made of ballistic nylon so that handles for carrying the PDA can be easily sewn onto the housing and so that the housing can further resist any shock from the environment. If the case of the PDA is hard, there can be sockets provided where the handle can be easily attached or detached using a pair of nuts. A lanyard may be provided in lieu of a handle to allow the user to easily transport the PDA. Furthermore, the PDA may have a retractable stand that allows the user to set the PDA on the ground and still be able to see the monitor while the user engages in another activity, thereby facilitating access to the information by the user.
(2) U.S. Pat. No. 6,985,580 to Lu et al.

U.S. Pat. No. 6,985,580 issued to Lu et al. on Jan. 10, 2006 teaches an auto-released hinge for a mobile phone, which has a barrel with two open ends. The barrel has a first flange formed inside the barrel. A first spiral slot is defined in the first flange. Two stop slots are defined in the barrel and two second spiral slots are defined between the respective stop slots and the first flange. A pintle is rotatably received in the barrel, and has a first end extending out from the barrel and a second flange formed adjacent a second end of the pintle. A protrusion is formed at an outer periphery of the pintle and received in the first spiral slot. Two ridges are formed adjacent the second flange and respectively blocked in the stop slots. A resilient member is provided outside the second end of the pintle. A fastener is positioned in the barrel to fasten the pintle and the resilient member.

### (3) United States Patent Application Publication Number 2005/0210173 to Kehoe et al.

United States Patent Application Publication Number 2005/0210173 published to Kehoe et al. on Sep. 22, 2005 teaches an adapter unit for a personal digital assistant. More specifically, an adapter unit that has a handle grip.
(4) U.S. Pat. No. 6,886,221 to Minami et al.

U.S. Pat. No. 6,886,221 issued to Minami et al. on May 3, 2005 teaches a folding device containing a stationary part, a movable part disposed to be rotatable in flip-up (unfolding) and flip-down (folding) directions, a force-applying section disposed between the two parts, which urges the movable part in either direction according to a state of the movable part, a reversing section for allowing the force-applying section to change a direction of urging of the movable part into the flip-up (unfolding) direction when the movable part is in a folded state, and an actuator for operating the reversing section. Pressing the actuator being in the folded state allows the reversing section to switch the direction of urging of the movable part into flip-up (unfolding) direction. The stationary and the movable housings are connected to the stationary and the movable parts of the folding device, respectively. The structures can provide a folding device equipped with a simple one-hand flipping-up (unfolding), and electronic equipment using the device.

(5) U.S. Pat. No. 6,837,435 to Kehoe et al.

U.S. Pat. No. 6,837,435 issued to Kehoe et al. on Jan. 4, 2005 teaches an adapter unit for a personal digital assistant. More specifically, an adapter unit that has a handle grip.

(6) U.S. Pat. No. 6,820,813 to Salvato et al.

U.S. Pat. No. 6,820,813 issued to Salvato et al. on Nov. 23, 2004 teaches an adapter unit for a personal digital assistant.

(7) United States Patent Application Publication Number 2003/0089832 to Gold. United States Patent Application Publication Number 2003/0089832 published to Gold on May 15, 2003 teaches a multi-functional articulated device with an adjustable set of rotationally locking leaves, which can provide a PDA or other handheld device with a hand-carrying ability that creates a more secure grip on the PDA while still allowing use of the hand for other tasks. The device is attachable to a pocket, a belt, or waistband, further has a surface stand up ability for multi-person viewing of the handheld device, also incorporates a paper handling capability for users that require the ability to input data into their handheld device while still holding paper documents, further allows the user to place a nametag or business card on the device in such a way as to create a breast pocket personal identification methodology for meetings and conventions, further allows the user to display the screen of their handheld device in such a way as to create an electronic breast pocket personal display methodology for meetings, conventions, marketing, and sales purposes, further allows the user to place their handheld device down on dirty or wet surfaces without affecting the handheld device, further creates multiple configurations that can hold handheld devices above desk level so that additional components like keyboards and power cables can be easily attached, further allows the user to display a handheld device in a portrait or landscape-viewing mode, further allows the user mount a handheld device on a vehicle dashboard, and further allows the user to attach additional accessories to amplify the users ability to see the screen of the handheld device attached to the invention.
(8) U.S. Pat. No. 6,016,423 to Ross et al.

U.S. Pat. No. 6,016,423 issued to Ross et al. on Jan. 18, 2000 teaches a bracing system that protects and secures the internal components of a mobile communication system. The bracing system includes an upper housing including a shock resistant material. The upper housing includes a monitor cavity, elevated portions surrounding the monitor cavity and formed in the upper housing, and elastomer sections disposed on the elevated portions. In addition, the upper housing includes a breakage resistant transparent material placed on the elastomer sections and in conformity with the monitor cavity, a display monitor being protected by the breakage resistant material, and a shock absorbing material disposed around the peripheries of the breakage resistant transparent material and the display monitor. The shock absorbing material is mounted to at least one of the breakage resistant transparent material and the display monitor. The upper housing also includes a mounting bracket biasing the display monitor to the upper housing and the breakage resistant material, and mounted to the upper housing, an integral keyboard formed of a water resistant material including elevated keys and mounting holes arranged around the periphery and between selected keys, and a first printed circuit board including switches selectively activated in response to depression of the elevated keys and mounted to the upper housing through the mounting holes in the integral keyboard.

(9) U.S. Pat. No. 5,594,953 to Ross et al.

U.S. Pat. No. 5,594,953 issued to Ross et al. on Jan. 14, 1997 teaches a mobile satellite system including a satellite communication switching office having a satellite antenna for receiving/transmitting a satellite message via a satellite from/to a vehicle using a mobile communication system, a satellite interface system, and a fleet management system including a central controller. The mobile communication system includes a housing having a shock resistant material. The housing includes end bumpers of an elastomeric material for absorbing shock experienced by the housing. The end bumpers each include recessed handles on an upper surface of the mobile communicator system and ribbed protruded finger grips on a bottom surface of the mobile communication system. The mobile communication system also includes an input device for inputting data. The input device includes a keyboard including a rubber/carbon membrane and mounted in the housing a first seal to prevent fluid from entering the mobile communication system between the input device and the housing. The mobile communication system also includes a central processing unit disposed in the housing that receives either data from the input device or sensor data received from the mobile sensing station. The central processing unit also outputs satellite data to the satellite interface system for transmission to the satellite. The mobile communication system further includes a display monitor including tempered glass having the ability to withstand.

### 3. SUMMARY OF THE INVENTION

An object of the present invention is to encase and protect a communication device.
Another object of the present invention is to allow the one-handed use of a communication device.
Another object of the present invention is a communication device hard case that allows for the tilted table-top use of the enclosed communication device.

### 4. BRIEF DESCRIPTION OF THE DRAWING

The figures on the drawing are briefly described as follows:

FIG. 1 is a diagrammatic perspective view of the present invention in the in-use position;

FIG. 2 is an enlarged diagrammatic side elevational view taken generally in the direction of ARROW 2 in FIG. 1; and

FIG. 3 is an enlarged diagrammatic back elevational view taken generally in the direction of ARROW 3 in FIG. 2 of the present invention in the non-use position.

### 5. LIST OF REFERENCE NUMERALS UTILIZED IN THE DRAWING

### A. General

10 ergonomic hard case of present invention for communication device 12
12 communication device

### B. Overall Configuration of the Ergonomic Hard Case 10

14 body for being held in hand 24 of user 22 and for cradling communication device 12 therein so as to allow user 22 to utilize communication device 12
16 cover for protecting communication device 12
18 apparatus for holding fingers 20 of user 22 utilizing ergonomic hard case 10 so as to eliminate chance of communication device 10 falling out of hand 24 of user 22 during use
20 fingers of user 22
22 user
24 hand of user 22

### C. Specific Configuration of the Apparatus 18

26 pair of wings of apparatus 18
28 rear face of body 14
30 recess in rear face 28 of body 14
32 pins of pair of wings 26 of apparatus 18
34 finger-receiving through bores in pair of wings 26 of apparatus 18 for receiving tips of fingers 20 of user 22 during use
36 free edges of pair of wings 26 of apparatus 18
38 indentations in free edges 36 of pair of wings 26 of apparatus 18 for accommodating fingers 20 of the user 22
40 belt clip of body 14 for clipping body 14 to belt 42 of user 22
42 belt of user 22

### 6. DETAILED DESCRIPTION OF THE PREFERRED EMBODIMENTS

### A. General

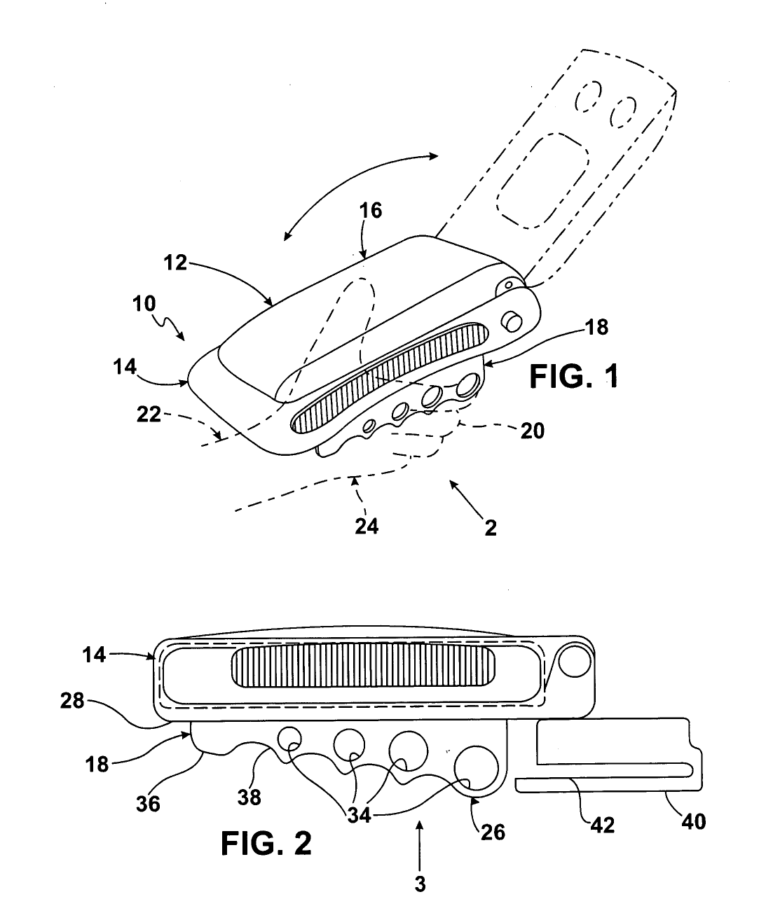

Referring now to the figures, in which like numerals indicate like parts, and particularly to FIG. 1, which is a diagrammatic perspective view of the present invention in the in-use position, the ergonomic hard case of the present invention is shown generally at 10 for a communication device 12.

### B. The Overall Configuration of the Ergonomic Hard Case 10

The ergonomic hard case 10 comprises a body 14, a cover 16, and apparatus 18 for holding the fingers 20 of a user 22 utilizing the ergonomic hard case 10. The body 12 is for being held in a hand 24 of the user 22 and for cradling the communication device 12 therein so as to allow the user 22 to utilize the communication device 12. The cover 16 is pivotally mounted to the body 14 and is for protecting the communication device 12. The apparatus 18 is pivotally mounted to the body 14 and is for holding the fingers 20 of a user 22 utilizing the communication device 12 so as to eliminate a chance of the communication device 10 falling out of the hand 24 of the user 22 during use.

### C. The Specific Configuration of the Apparatus 18

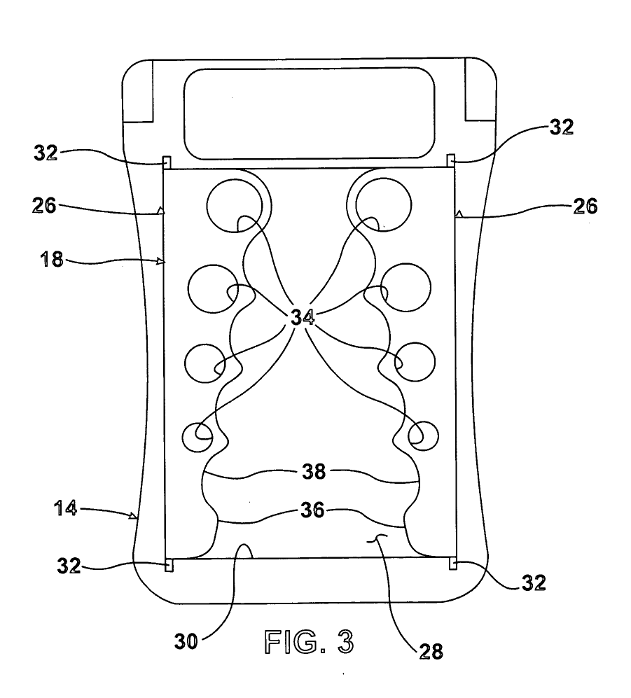

The specific configuration of the apparatus 18 can best be seen in FIGS. 2 and 3, which are, respectively, an enlarged diagrammatic side elevational view taken generally in the direction of ARROW 2 in FIG. 1, and an enlarged diagrammatic back elevational view taken generally in the direction of ARROW 3 in FIG. 2 of the present invention in the non-use position, and as such, will be discussed with reference thereto.

The apparatus 18 comprises a pair of wings 26. The pair of wings 26 of the apparatus 18 are pivotally mounted to a rear face 28 of the body 14, and as such, have an extended position (FIG. 2) where they extend generally normally outwardly from the rear face 28 of the body 14 and a retracted position (FIG. 3) where they lie flat in the rear face 28 of the body 14.

The rear face 28 of the body 14 has a recess 30 therein. The recess 30 in the rear face 28 of the body 14 allows the pair of wings 26 of the apparatus 18 to lie unobtrusively flush with the rear face 28 of the body 14 when in the retracted position (FIG. 3).

The pair of wings 26 of the apparatus 18 are pivotally mounted to the rear face 28 of the body 14 by pins 32. The pins 32 of the pair of wings 26 of the apparatus 18 pivotally engage in the rear face 28 of the body 14 (FIG. 3).

The pair of wings 26 of the apparatus 18 contain finger-receiving through bores 34. The finger-receiving through bores 34 in the pair of wings 26 of the apparatus 18 are for receiving the tips of fingers 20 of the user 22 during use.

The finger-receiving through bores 34 of the pair of wings 26 of the apparatus 18 are graduated for accommodating the different sizes of the tips of the fingers 20 of the user 22.

The pair of wings 26 of the apparatus 18 further have free edges 36. The free edges 36 of the pair of wings 26 of the apparatus 18 contain indentations 38. The indentations 38 in the free edges 36 of the pair of wings 26 of the apparatus 18 are for accommodating the fingers 20 of the user 22.

The body 14 further has a belt clip 40. The belt clip 40 of the body 14 is for clipping the body 14 to a belt 42 of the user 22 (FIG. 2).

The invention claimed is:

1. A ergonomic hard case for a communication device, comprising:
a) a body;
b) a cover; and
c) apparatus for holding the fingers of a user utilizing the ergonomic hard case;
wherein said body is for being held in a hand of the user;
wherein said body is for cradling the communication device therein so as to allow the user to utilize the communication device;
wherein said cover is pivotally mounted to said body;
wherein said cover is for protecting the communication device;
wherein said apparatus is pivotally mounted to said body;
wherein said apparatus is for holding the fingers of a user utilizing the communication device so as to eliminate a chance of the communication device falling out of the hand of the user during use.

2. The case of claim 1, wherein said apparatus comprises a pair of wings; and
wherein said pair of wings of said apparatus are pivotally mounted to a rear face of said body, and as such, have an extended position where they extend generally normally outwardly from said rear face of said body and a retracted position where they lie flat in said rear face of said body.

3. The case of claim 2, wherein said rear face of said body has a recess therein;
wherein said recess in said rear face of said body allows said pair of wings of said apparatus to lie unobtrusively flush with said rear face of said body when in said retracted position.

4. The case of claim 2, wherein said pair of wings of said apparatus are pivotally mounted to said rear face of said body by pins;
wherein said pins of said pair of wings of said apparatus pivotally engage in said rear face of said body.

5. The case of claim 2, wherein said pair of wings of said apparatus contain finger-receiving through bores; and
wherein said finger-receiving through bores in said pair of wings of said apparatus are for receiving the tips of the fingers of the user during use.

6. The case of claim 5, wherein said finger-receiving through bores in said pair of wings of said apparatus are graduated for accommodating the different sizes of the tips of the fingers of the user.

7. The case of claim 2, wherein said pair of wings of said apparatus have free edges;
wherein said free edges of said pair of wings of said apparatus contain indentations; and
wherein said indentations in said free edges of said pair of wings of said apparatus are for accommodating the fingers of the user.

8. The case of claim 1, wherein said body has a belt clip; and
wherein said belt clip of said body is for clipping said body to a belt of the user.

9. An improved ergonomic hard case for a communication device and being of the type having a body and a cover, wherein the body is held in a hand of the user and cradles the communication device therein so as to allow the user to utilize the communication device, and wherein the cover is pivotally mounted to the body and protects the communication device, wherein the improvement comprises apparatus for holding the fingers of a user utilizing the ergonomic hard case;
wherein said apparatus is for pivotally mounting to the body; and
wherein said apparatus is for holding the fingers of a user utilizing the communication device so as to eliminate a chance of the communication device falling out of the hand of the user during use.

10. The improvement of claim 9, wherein said apparatus comprises a pair of wings; and
wherein said pair of wings of said apparatus are pivotally mounted to a rear face of the body, and as such, have an extended position where they extend generally normally outwardly from the rear face of the body and a retracted position where they lie flat in the rear face of the body.

11. The improvement of claim 10, wherein the rear face of the body has a recess therein;
wherein said recess in the rear face of the body allows said pair of wings of said apparatus to lie unobtrusively flush with the rear face of the body when in said retracted position.

12. The improvement of claim 10, wherein said pair of wings of said apparatus are pivotally mounted to the rear face of the body by pins;
wherein said pins of said pair of wings of said apparatus pivotally engage in the rear face of the body.

13. The improvement of claim 10, wherein said pair of wings of said apparatus contain finger-receiving through bores; and
wherein said finger-receiving through bores in said pair of wings of said apparatus are for receiving the tips of the fingers of the user during use.

14. The improvement of claim 13, wherein said finger-receiving through bores in said pair of wings of said apparatus are graduated for accommodating the different sizes of the tips of the fingers of the user.

15. The improvement of claim 10, wherein said pair of wings of said apparatus have free edges;
wherein said free edges of said pair of wings of said apparatus contain indentations; and
wherein said indentations in said free edges of said pair of wings of said apparatus are for accommodating the fingers of the user.
